(19) United States
(12) Patent Application Publication
(10) Pub. No.: US 2009/0316775 A1
(43) Pub. Date: Dec. 24, 2009

(54) VIDEO ENCODING AND DECODING METHOD AND SYSTEM THEREOF

(76) Inventors: Chia-Yun Cheng, Hsinchu City (TW); Chi-Cheng Ju, Hsinchu City (TW); Yung-Chang Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/142,812

(22) Filed: Jun. 20, 2008

(51) Int. Cl. H04N 11/02

(52) U.S. Cl. 375/240.01; 375/E07.076

(57) ABSTRACT

A video encoding system for encoding at least one frame, which includes a plurality of data units, to a bit stream. The system includes: a scaling unit, for scaling a data unit of a current frame to generate a scaled data unit in a first mode; and a video encoder, coupled to the scaling unit, for directly retrieving the scaled data unit from the scaling unit and encoding the scaled data unit to generate a coded data unit in the first mode.

### BACKGROUND OF THE INVENTION

The present invention relates to a video encoding method, a video decoding method and a system thereof, and particularly relates to a video encoding and decoding method in an RPR (Reference Picture Resampling) mode and a system thereof.

FIG. 1 is a related art video processing system 100. As shown, the video processing system 100 includes a video processing unit 101, a scaling unit 103 and a memory unit 105 (other conventional devices such as a bus and a control unit are not shown in the diagram). If the video processing system 100 is a video encoding system, the video processing unit 101 is a video encoder. Also, if the video processing system 100 is a video encoding system with an RPR mode, the scaling unit 103 is utilized for scaling a current frame to generate a scaled current frame with a size the same as a next frame, when the current frame is a reference frame for the next frame. The video processing unit 101 further encodes the current frame according to the scaled current frame. It is noted that the RPR mode is a mode allows video encoder or decoder to change picture size on a frame-by-frame basis. The video processing system conforms to any video standards having the RPR mode such as H.263 and RealVideo standards.

In this system, however, the scaling unit 103 scales the current frame and the whole current frame is stored to the memory unit 105. The video processing unit 101 reads the scaled current frame from the memory unit 105. Since such operations need to access the whole frame, a longer delay time is generated and a large bandwidth is needed. Also, the system resource such as CPU million instructions per second (MIPS) or memory unit space is occupied since a full frame is processed or accessed.

If the video processing system 100 is a video decoding system, the video processing unit 101 is a video decoder. The operation of a video decoding system of a RPR mode can be shown as follows: it is determined if a previous picture and a current picture have the same size; if the answer is no and the current frame is a P frame, the previous frame is re-sampled (i.e. scaled), and the current time is decoded. The steps of scaling the previous frame and decoding the current frame all take time and thus a longer processing time is produced. Similarly, the system resource such as CPU MIPS or memory unit space is occupied since a full frame is processed or accessed.

### SUMMARY OF THE INVENTION

One embodiment of the present invention discloses a video encoding system for encoding at least one frame, which includes a plurality of data units, to a bit stream. The system includes: a scaling unit, for scaling a data unit of a current frame to generate a scaled data unit in a first mode; and a video encoder, coupled to the scaling unit, for directly retrieving the scaled data unit from the scaling unit and encoding the scaled data unit to generate a coded data unit in the first mode.

In another embodiment, a video encoding method for encoding at least one frame, which includes a plurality of data units, to a bit stream is also disclosed. The method corresponds to the above-mentioned video encoding system and includes: scaling a data unit of a current frame to generate a scaled data unit in a first mode; and encoding the scaled data unit without storing the scaled data to generate a coded data unit.

One embodiment of the present invention discloses a video decoding system for decoding a bit stream to at least one frame, which includes a plurality of data units. The system includes: a control unit, for obtaining picture size information of a next frame and a current frame before a data unit of the current frame is scaled; a video decoder, coupled to the control unit, for decoding the data unit of the current frame to generate a decoded data unit; and a scaling unit, coupled to the video decoder and the control unit, for scaling the decoded data unit, when the current frame and the next frame have different picture sizes.

In another embodiment, a video decoding method for decoding a bit stream to at least one frame, which includes a plurality of data units, is also disclosed. The method corresponds to the above-mentioned video decoding system and includes: obtaining picture size information of a next frame and a current frame before a data unit of the current frame is scaled; decoding the data unit of the current frame to generate a decoded data unit; and scaling the decoded data unit when the current frame and the next frame have different picture sizes.

Via the above-mentioned embodiments, since only part of a frame is decoded or encoded each time, the system bandwidth can be saved, and the system resources are flexible. Also, the picture size of a next frame is obtained.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a related art video processing system.

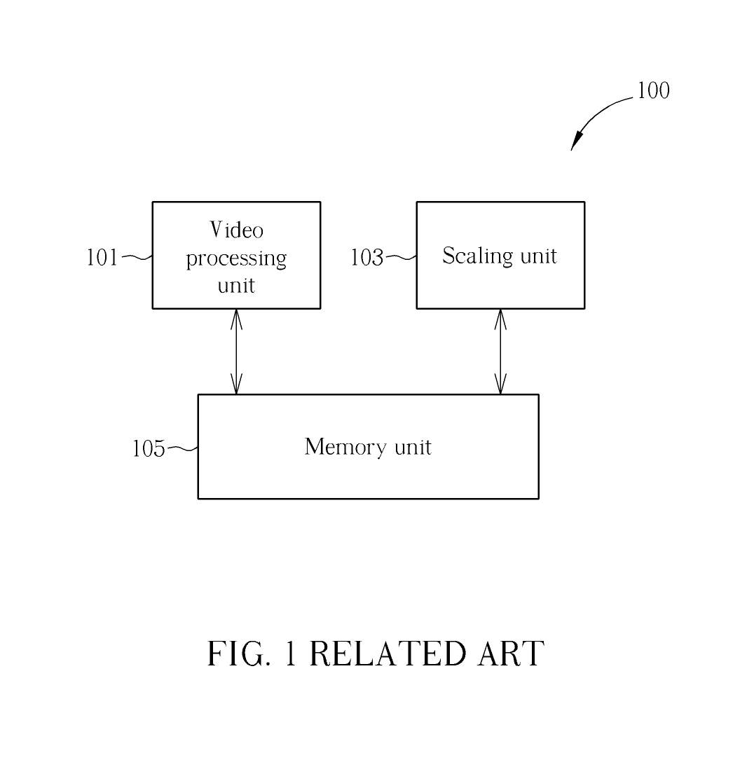

FIG. 2 is a block diagram illustrating a video encoding system according to a preferred embodiment of the present invention.

FIG. 3 is a schematic diagram illustrating the operations of the video encoding system according to a preferred embodiment of the present invention in an MB mode and an SL mode.

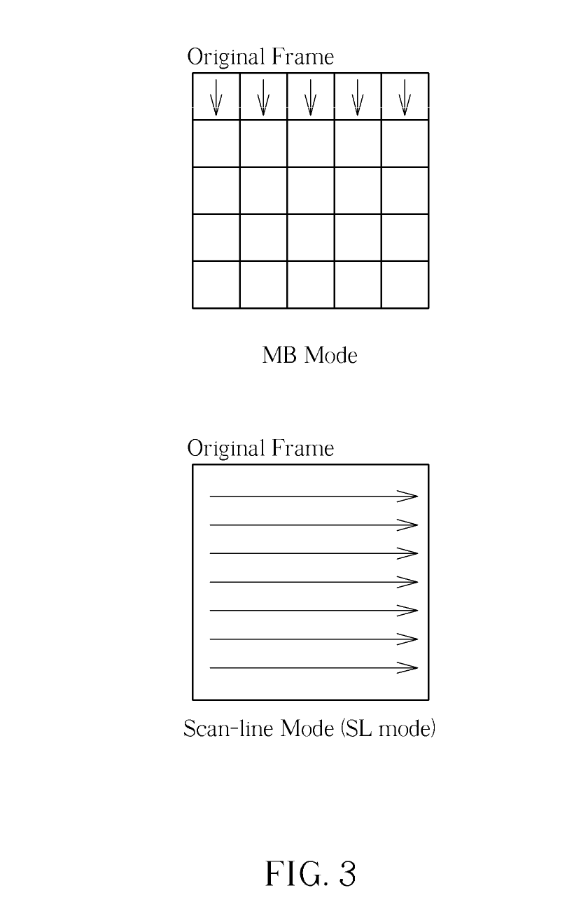

FIG. 4 is a flow chart illustrating a video encoding method according to the first embodiment of the present invention.

FIG. 5 is a flow chart illustrating a video encoding method according to a second embodiment of the present invention.

FIG. 6 is a flow chart illustrating a video encoding method according to a third embodiment of the present invention.

FIG. 7 is a block diagram illustrating a video decoding system according to a preferred embodiment of the present invention.

FIG. 8 is a flow chart illustrating a video decoding method according to a preferred embodiment of the present invention.

FIG. 9 is a schematic diagram illustrating the operation of obtaining a next picture size.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

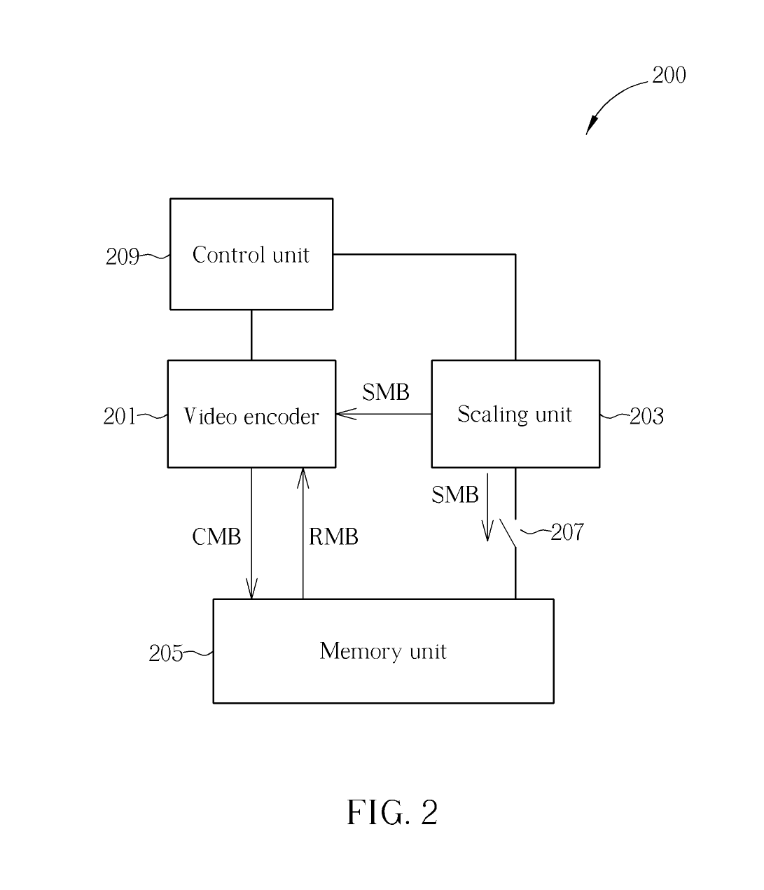

FIG. 2 shows a video encoding system 200 according to an embodiment of the invention. As shown, the video encoding system 200 includes a video encoder 201, a scaling unit 203, a memory unit 205, and a switch 207. The scaling unit 203 can operate in an MB mode and an SL (scan-line) mode. As shown, the unit used for scaling in the MB mode is a macro block; that is, a macro block is scaled to generate a scaled macro block, where a whole frame is scaled to generate a scaled frame in the SL mode. The video encoder 201 further encodes the scaled macro block or the scaled frame.

In the MB mode, the scaling unit 203 scales a macro block of a current frame to generate a scaled macro block SMB. The scaled macro block SMB can be transmitted to the video encoder 201 for encoding, or be transmitted to the memory unit 205 if the scaled macro block SMB is a reference macro block for the next one. The video encoder 201 encodes the macro block of the current frame or the scaled macro block SMB to generate a coded macro block CMB. If an original picture size equals the current picture size, the video encoder 201 directly encodes the macro block of the current frame instead of the scaled macro block. Otherwise, the video encoder 201 encodes the scaled block. Also, the scaled macro block SMB may be used as the reference macro block RMB. It is noted that the video encoding system 200 is not limited to utilize a single macro block as the unit for encoding and scaling; more than one macro block can also be utilized as the unit for encoding and scaling.

The switch 207 is for determining whether the memory unit 205 is coupled to the scaling unit 203 or not, thereby the scaling unit 203 can be connected or disconnected to the memory unit 205 according to different requirements. It should be noted that the memory unit 205 and the switch 207 are optional devices. If the video encoder 201 does not need the reference macro block RMB, it can directly receive the macro block or the scaled macro block SMB from the scaling unit 203 and perform encoding operations.

In the SL mode, the scaling unit 203 scales a whole frame to generate a scaled frame, and the scaled frame is stored to the memory unit 205. Also, the video encoder 201 reads the scaled frame from the memory unit 205 for encoding the scaled frame or utilizes the scaled frame as a reference frame. With the video encoding system 200, the bandwidth requirement and occupied system resources are decreased and further, processing time is reduced.

Furthermore, the video encoding system 200 can include a control unit 209 coupled to the video encoder 201 and the scaling unit 203. The control unit 209 can be utilized for turning on an RPR mode of the video encoding system 200 so that the scaling unit 203 can perform the step of scaling a macro block for the RPR mode. In some cases, the control unit 209 turns on the RPR mode of the video encoding system 200 when system resources thereof are not sufficient. The system resources can include hardware state of the devices related with the video encoding system 200, such as network bandwidth, CPU million instructions per second (MIPS), DRAM bandwidth, memory space or power condition.

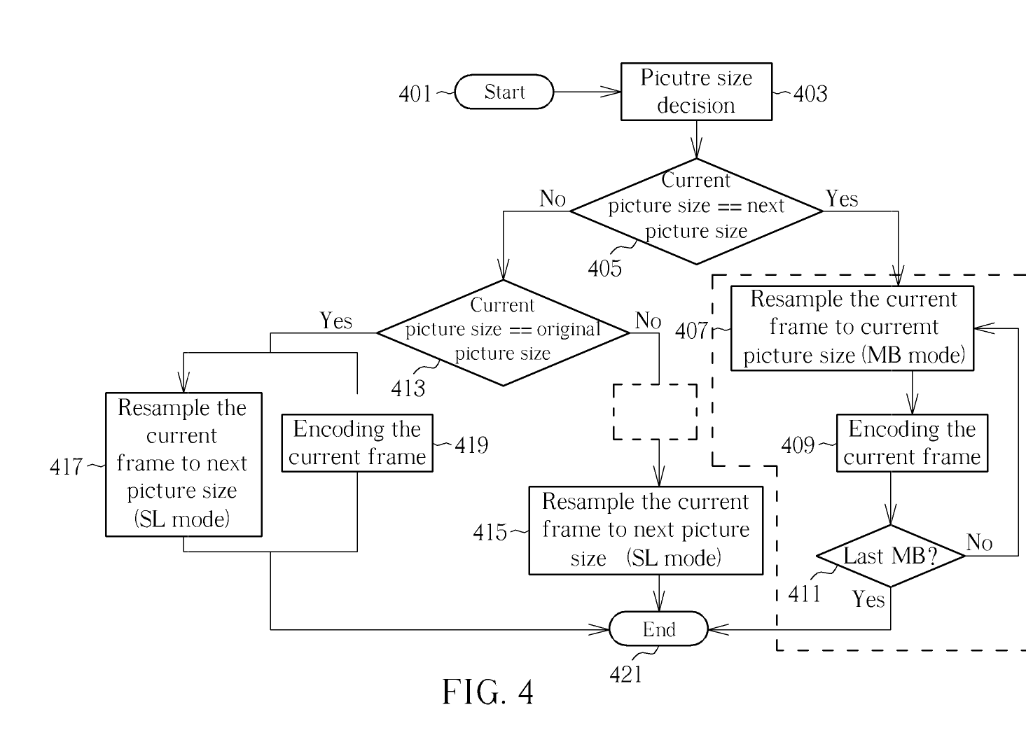

FIGS. 4, 5 and 6 are flow charts illustrating a video encoding method according to a first, second and third embodiment of the invention, respectively. It should be noted that these flowcharts are only examples and are not meant to limit the scope of the invention.

As shown in FIG. 4, the steps include:
Step 401: Start;
Step 403: Decide picture sizes. This step can be performed via a control unit 209 for controlling the operations of the video encoding system 200;
Step 405: Determine if the current picture size equals the next picture size. If yes, go to Step 407; other wise go to step 413;
Step 407: Scale (resample) the current frame to the current picture size. As mentioned above, since this step is in MB mode in this embodiment, one macro block is scaled each time instead of a whole frame;
Step 409: Encode the current frame;
Step 411: Determine if the macro block is a last macro block. If yes, end; if not, go back to step 407;
Step 413: Determine if the current picture size equals to the original picture size. If not, perform the steps 407, 409, and 411 again and then step 415; if yes, perform steps 417 and 419; It should be noted that the dotted block, following the step 413 when it is determined to be No therein, indicates the steps 407, 409, and 411, and the paths thereof, but are not illustrated for brevity.
Step 415: Scale the current frame to the next picture size. In this embodiment, this step utilizes the SL mode, but it still can utilize the MB mode. In this step, the current frame is scaled to the next picture size as a reference frame for the next frame;
Step 417: Scale the current frame to the next picture size. In this embodiment, this step utilizes the SL mode, but it still can utilize the MB mode. In this step, the current frame is scaled to the next picture size as a reference frame for the next frame;
Step 419: Encode the current frame (because the picture size is not changed as determined in step 413, no scaling is needed before encoding);
Step 421: End.

It is noted that both the steps 419 and 417 are performed following the step 413 when it is determined to be Yes therein. That is the scaling unit 203 may scale the current frame to the next picture size and the video encoder 201 may encode the current frame at the same time. Further, as previously described, step 403 can be performed via a control unit 209 for controlling the operations of the video encoding system 200. The control unit can decide to turn on the RPR mode of the video encoding system 200 when required. For example, the RPR mode may be turned on when available system resources are not sufficient, such as network bandwidth, CPU MIPS, DRAM bandwidth, memory space and power condition.

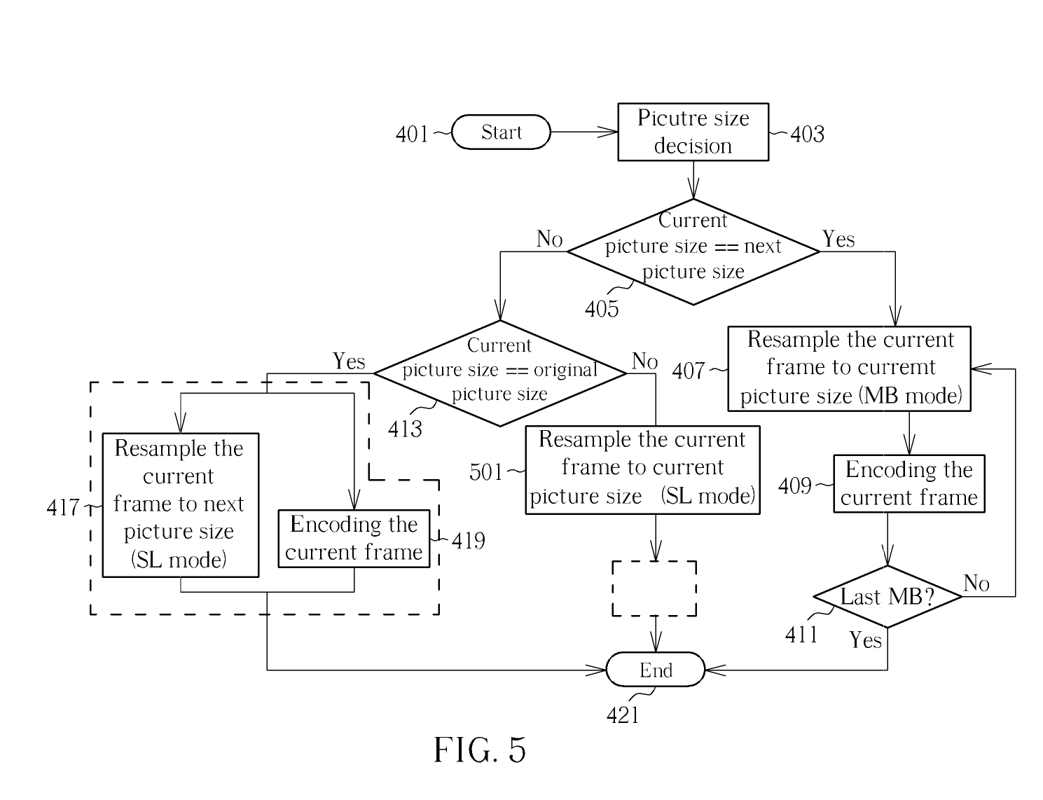

The method shown in FIG. 5 has similar steps as FIG. 4 except the processing steps when the original picture size, the current picture size and the next picture size are all different; that is when it is determined to be No in both the steps 405 and 413. In this method, the current frame is scaled to the current picture size (step 501) followed the steps 419 and 421. Similarly, although the step 501 utilizes the SL mode, it can also utilize MB mode. Similarly, the dotted block following the step 501 indicates the steps 417 and 419 and the paths thereof, but are not illustrated for brevity.

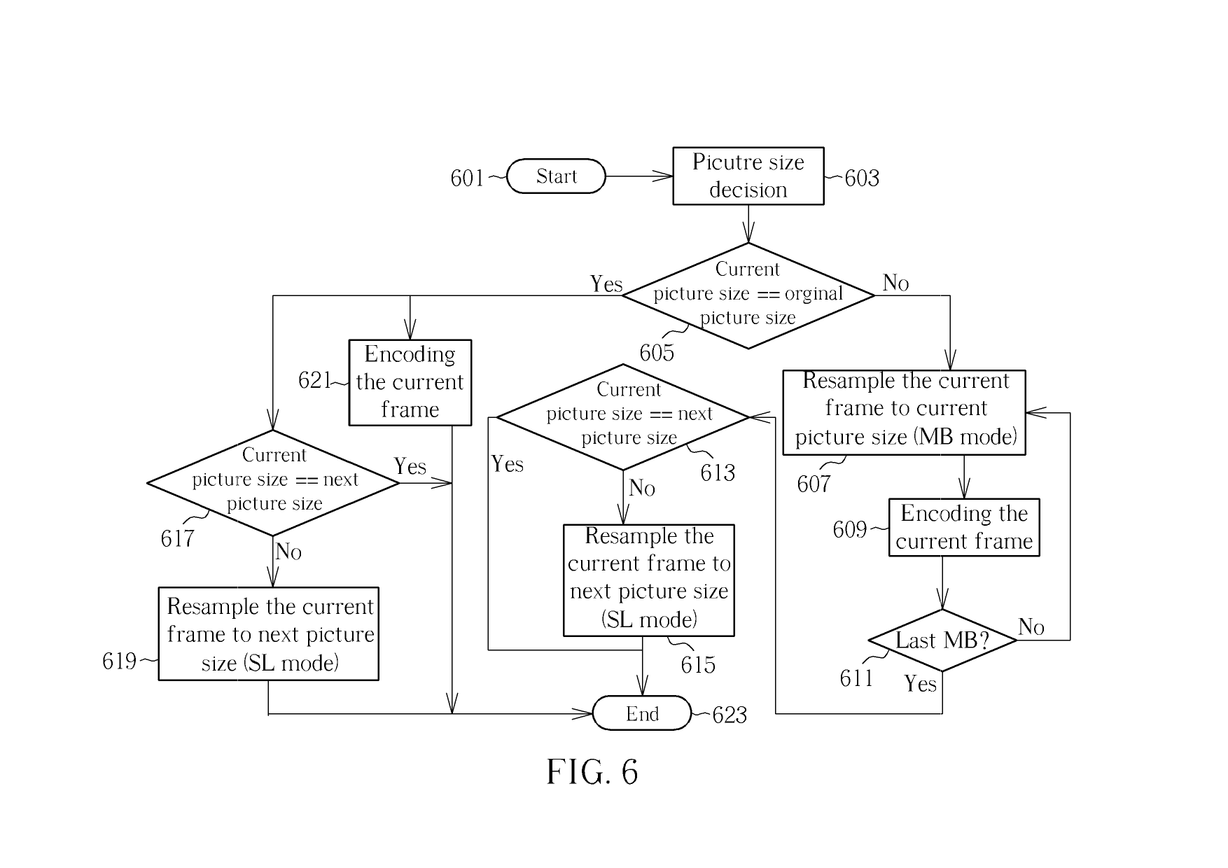

The steps of the method shown in FIG. 6 are different from the steps shown in FIG. 4 and FIG. 5. As shown in FIG. 6, the method includes:
Step 601: Start;
Step 603: Decide picture sizes;
Step 605: Determine if the current picture size equals the original picture size. If yes, go to step 617 and 621; otherwise go to step 607;
Step 607: Scale (resample) the current frame to the current picture size. As mentioned above, since this step is performed in MB mode in this embodiment, one macro block is scaled each time instead of a whole frame;
Step 609: Encode the current frame.
Step 611: Determine if the macro block is a last macro block. If yes, proceed to step 613; if not, go back to step 607;
Step 613: Determine if the current picture size equals the next picture size. If yes, go to end; otherwise go to step 615;
Step 615: Scale the current frame to the next picture size;
Step 617: Determine if the current picture size equals the next picture size. If yes, go to end; otherwise go to step 619;
Step 619: Scale the current frame to the next picture size. In this embodiment, steps 615 and 619 utilize the SL mode, but still can utilize the MB mode. In this step, the current frame is scaled to the next picture size as a reference frame for the next frame;
Step 621: Encode the current frame;
Step 623: End.

The above-mentioned embodiments follow an RPR (Reference Picture Resampling) mode that scales a reference frame to a size the same as the frame to be encoded when the two sizes are different. The steps shown in FIGS. 4, 5 and 6 are only examples and all modifications following the rules below should fall in the scope of the present invention. The operations of the methods shown in FIGS. 4, 5 and 6 can be summarized as follows.

If the current picture size is different from the original picture size, and the current picture size is identical to the next picture size, the scaling unit generates the scaled macro block and the video encoder encodes the scaled macro block.

If the original picture size, the current picture size and the next picture size are the same, the current frame is encoded according to the macro block. That is, no scaling operation is performed.

If the original picture size, the current picture size and the next picture size are different from each other, the scaling unit scales the current frame to the current frame picture size, the video encoder encodes the scaled current frame, and then the scale unit scales the current frame to the next picture size.

If the current picture size and the next picture size are different, and the current picture size and the original picture size are the same, the video encoder encodes the current frame and the scaling unit scales the current frame to the next picture size.

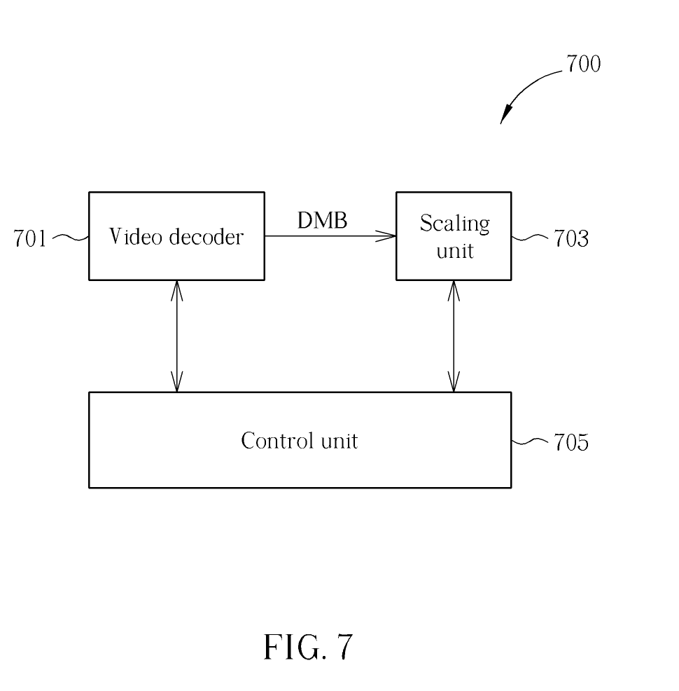

The present invention also provides a video decoding system utilizing a similar concept. FIG. 7 is a block diagram illustrating a video decoding system 700 for a bitstream according to an embodiment of the invention. As shown, the video decoding system 700 includes a video decoder 701, a scaling unit 703 and a control unit 705. The control unit 705 controls the decoder 701 and the scaling unit 703, and obtains picture size information of a current frame and a next frame. The video decoder 701 decodes a macro block of the current frame to generate a decoded macro block DMB. The scaling unit 703 scales the decoded data unit if the current frame and the next frame have different picture sizes; that is when RPR mode is utilized in the bitstream. The video decoder 701 and scaling unit 703 may operate in parallel; that is the video decoder 701 may decodes a macro block of the current frame while the scaling unit 703 scales another decoded data unit.

Conventionally, a bitstream is parsed to video data and audio data, and then the video data is de-packed to a plurality of frames. Each frame has a slice header with picture size information. Therefore, the above-mentioned picture sizes can be obtained from the slice header before the video decoding process. Further, in an embodiment of the invention, the bitstream can be a RealVideo bitstream and the video decoding system conforms to any video standards having the RPR mode such as H.263 and RealVideo standards. With the video decoding system 700, the bandwidth requirement and occupied system resources are decreased and further, processing time is reduced.

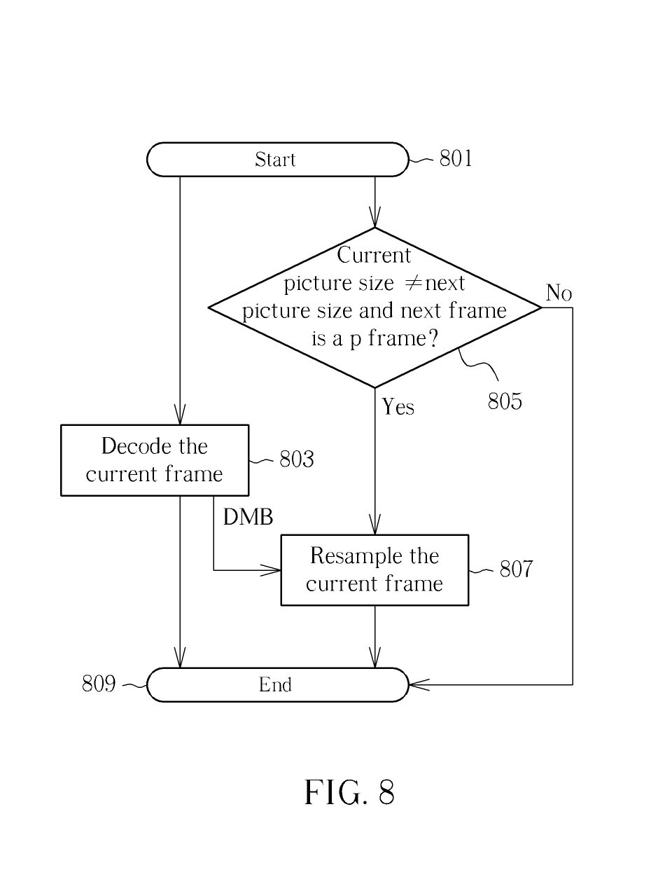

FIG. 8 is a flow chart illustrating a video decoding method according to a first embodiment of the present invention, which corresponds to the system shown in FIG. 7. As shown in FIG. 8, the video decoding method includes:
Step 801: Start;
Step 803: Decode a macro block of the current frame to generate a decoded macro block DMB. It should be noted that the scope of the invention is not limited to utilize only one macro block. That is, other data units of a frame (ex: more than one macro block or other types of data units that can form a frame) can also be utilized;
Step 805: Determine if a picture size of current frame equals to that of a next frame. Also, it is determined whether the next frame is a P frame in this step in this embodiment. If it is determined that the current picture size is not equal to the next picture size and the next frame is a P frame, the method goes to step 807; otherwise the method goes to step 809. However, the concept of the embodiment is not limited to a P frame; other kinds of frames having similar characteristics can also apply the video decoding method of the invention;
Step 807: Scale the macro block DMB from the step 803 to generate a scaled macro block;
Step 809: End.

According to the above-mentioned description, the picture sizes can be obtained initially, and a macro block is utilized as a unit for decoding and scaling. Thus the problems of processing time shown in the related art can be avoided.

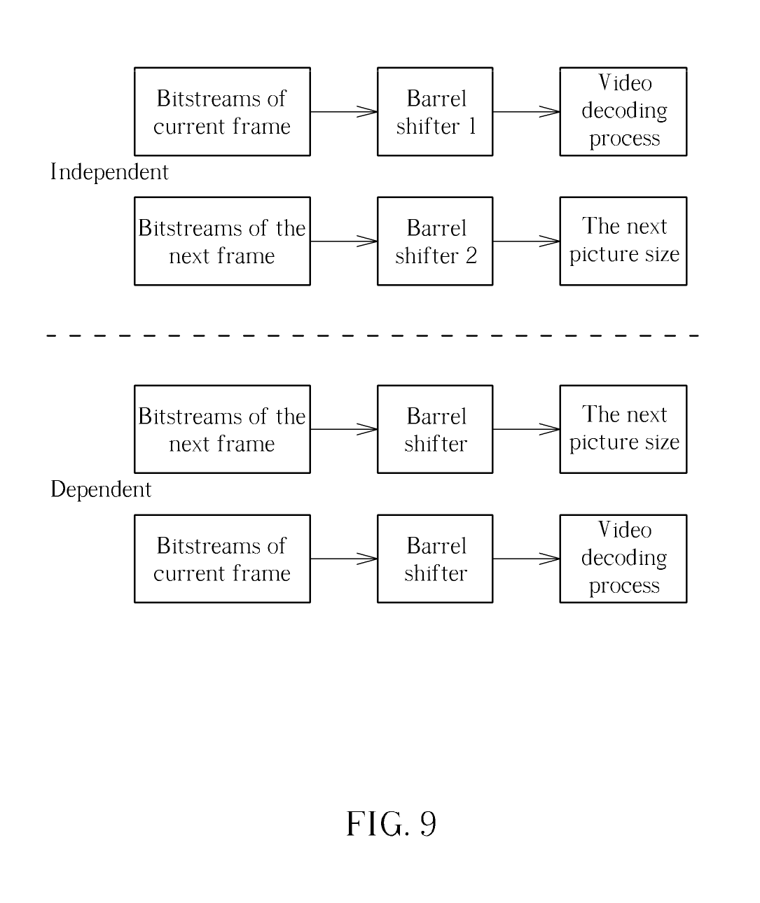

FIG. 9 is a schematic diagram illustrating the operation of obtaining a next picture size. Conventionally, a barrel shifter is utilized as a parser, and FIG. 9 illustrates two operations for obtaining a next picture size of a next frame. As shown, the independent operation utilizes two independent barrel shifters for a bit stream of a current frame and a bit stream of the next frame, respectively. As shown, the bit stream of a current frame starts a video decoding operation after being processed by the barrel shifter 1. Also, the next picture size is obtained via the bit stream of the next frame after being processed by the barrel shifter 2.

The dependent operation utilizes a single barrel shifter for both the bit streams of current frame and next frame and utilizes software to control the operation. Since the detailed operations are well known by persons skilled in the art, they are omitted for brevity.

Those skilled in the art will readily observe that numerous modifications and alterations of the device and method may be made while retaining the teachings of the invention.

What is claimed is:

1. A video encoding system for encoding at least one frame to a bit stream, the frame including a plurality of data units, the system comprising:
a scaling unit, for scaling a data unit of a current frame to generate a scaled data unit in a first mode; and
a video encoder, coupled to the scaling unit, for directly retrieving the scaled data unit from the scaling unit and encoding the scaled data unit to generate a coded data unit in the first mode.

2. The system of claim 1, further comprising:
a memory unit, for storing the coded data unit, or storing the scaled data unit to be a reference data unit for the video decoder;
wherein the scaling unit scales the current frame to generate a scaled current frame to be stored in the memory unit in a second mode, and the encoder reads the scaled current frame from the memory unit as a reference frame, or reads the scaled current frame from the memory unit to encode the scaled frame in the second mode.

3. The system of claim 2, further comprising:
a switch, coupled between the memory unit and the scaling unit, for coupling the memory unit to the scaling unit or decoupling the memory unit from the scaling unit.

4. The system of claim 1, wherein the video encoder repeatedly performs the steps of scaling a data unit of the current frame to generate a scaled data unit and encoding the scaled data unit to generate a coded data unit until all data units of the current frame are encoded and an encoded current frame are generated.

5. The system of claim 1, further comprising a control unit coupled to the video encoder and the scaling unit, for turning on an RPR (reference picture re-sampling) mode of the video encoding system so that the step of scaling a data unit is performed.

6. The system of claim 5, wherein the control unit turns on the RPR mode of the video encoding system when system resources thereof are not sufficient.

7. The system of claim 6, wherein the system resources are network bandwidth, CPU million instructions per second (MIPS), DRAM bandwidth, memory space or power condition.

8. The system of claim 1, further comprising:
a control unit coupled to the video encoder and the scaling unit, for controlling the operations of the scaling unit and the video encoder, wherein the control unit decides an original picture size of an original frame preceding the current frame, a current picture size of the current frame and a next picture size of a next frame following the current frame;
wherein when the original picture size is different from the current picture size, and the current picture size is identical to the next picture size, the scaling unit generates the scaled data unit and the video encoder encodes the scaled macro block.

9. The system of claim 8, wherein the video encoder encodes the current frame according to the data unit when the original picture size, the current picture size and the next picture size are the same.

10. The system of claim 8, wherein the scaling unit scales the current frame to the current frame picture size, the video encoder encodes the current frame, and then the scale unit scales the current frame to the next picture size when the original picture size, the current picture size and the next picture size are different from each other.

11. The system of claim 8, wherein the video encoder encodes the current frame and the scaling unit scales the current frame to the next picture size when the current picture size and the next picture size are different, and the current picture size and the original picture size are the same

12. A video decoding system for decoding a bit stream to at least one frame, the frame including a plurality of data units, the system comprising:
a control unit, for obtaining picture size information of a next frame and a current frame before a data unit of the current frame is scaled;
a video decoder, coupled to the control unit, for decoding the data unit of the current frame to generate a decoded data unit; and
a scaling unit, coupled to the video decoder and the control unit, for scaling the decoded data unit, when the current frame and the next frame have different picture sizes.

13. The system of claim 12, wherein the picture size information is obtained from a slice header of the frame.

14. The system of claim 12, wherein the step of decoding a data unit of the current frame follows an RPR (reference picture re-sampling) standard.

15. A video encoding method for encoding at least one frame to a bit stream, the frame including a plurality of data units, the method comprising:
scaling a data unit of a current frame to generate a scaled data unit in a first mode when an RPR (reference picture re-sampling) mode is enabled; and
encoding the scaled data unit without storing the scaled data to generate a coded data unit.

16. The method of claim 15, further comprising:
scaling a current frame to generate a scaled current frame in a second mode to be stored in a memory unit; and
reading the scaled current frame from the memory unit as a reference frame, or reading the scaled current frame to encode the scaled frame in the second mode.

17. The method of claim 15, wherein the steps of scaling a data unit of the current frame to generate a scaled data unit and encoding the scaled data unit to generate a coded data unit are performed repeatedly until all data units of the current frame are encoded and an encoded current frame are generated.

18. The method of claim 15, wherein the step of encoding the frame follows an RPR (reference picture re-sampling) standard.

19. The method of claim 15, comprising:
deciding an original picture size of an original frame preceding the current frame, a current picture size of the current frame and a next picture size of a next frame following the current frame;
wherein when the original picture size is different from the current picture size, and the current picture size is identical to the next picture size, the steps of scaling a data unit and encoding the scaled data are performed.

20. The method of claim 19, further comprising:
encoding the current frame according to the data unit when the original picture size, the current picture size and the next picture size are the same.

21. The method of claim 19, further comprising:
scaling the current frame to the current frame picture size and encoding the current frame, and scaling the current frame to the next picture size when the original picture size, the current picture size and the next picture size are different from each other.

22. The method of claim 19, further comprising:
encoding the current frame and scaling the current frame to the next picture size when the current picture size and the next picture size are different, and the current picture size and the original picture size are the same.

23. A video decoding method for decoding a bit stream to at least one frame, the frame including a plurality of data units, the method comprising:
obtaining picture size information of a next frame and a current frame before a data unit of the current frame is scaled;
decoding the data unit of the current frame to generate a decoded data unit; and
scaling the decoded data unit when the current frame and the next frame have different picture sizes.

24. The method of claim 23, wherein the picture size information is obtained from a slice header of the frame.

25. The method of claim 23, wherein the step of decoding a data unit of the current frame follows an RPR (reference picture re-sampling) standard.
